(19) United States
(12) Patent Application Publication
(10) Pub. No.: US 2025/0058783 A1
(43) Pub. Date: Feb. 20, 2025

(54) SURFACE FRICTION DETERMINATION

(71) Applicant: VOLVO TRUCK CORPORATION, Göteborg (SE)

(72) Inventors: Nikhil BALIGA, Göteborg (SE); Umur ERDINC, Göteborg (SE)

(73) Assignee: VOLVO TRUCK CORPORATION, Göteborg (SE)

(21) Appl. No.: 18/799,078

(22) Filed: Aug. 9, 2024

(30) Foreign Application Priority Data
Aug. 17, 2023 (EP) 23191866.5

(51) Int. Cl. B60W 40/068

(52) U.S. Cl. CPC B60W 40/068; B60W 2520/125; B60W 2520/20

(57) ABSTRACT

A computer system is disclosed for determining a difference in surface friction between a first set of surface conditions and a second set of surface conditions. The computer system has processing circuitry configured to receive first data corresponding to a first set of surface conditions, the first data comprising a first slip angle for at least one wheel of a vehicle, receive second data corresponding to a second set of surface conditions, the second data comprising a second slip angle for at least one wheel of a vehicle, compare the first slip angle and the second slip angle, and upon there being a difference between the first slip angle and the second slip angle, determine that a surface friction associated with the first set of surface conditions is different from a surface friction associated with the second set of surface conditions. A lateral acceleration of the vehicle associated with the first data is substantially the same as a lateral acceleration of the vehicle associated with the second data.

### TECHNICAL FIELD

The disclosure relates generally to vehicle operation. In particular aspects, the disclosure relates to surface friction determination. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In vehicle operations, surface friction estimation is crucial to safe transport. This can be achieved using friction estimation models that calculate surface friction based on data from wheel torques, axle loads, cameras and the like. In many scenarios, vehicles travel pre-defined routes repeatedly, for example delivery routes for heavy-duty vehicles, such as trucks. Increasingly, this is being performed by autonomous vehicles. Surface conditions may change between journeys, for example due to weather and other factors, which can result in a change in surface friction even when the same route is travelled by the same vehicle. This can result in vehicles being controlled in a way that is not appropriate for current surface conditions.

It is therefore desired to develop a solution for determining a difference in surface friction between different surface conditions that addresses or at least mitigates some of these issues.

### SUMMARY

This disclosure attempts to address the problems noted above by providing systems, methods and other approaches for determining a difference in surface friction between a first set of surface conditions and a second set of surface conditions by comparing slip angles. This enables a change in surface friction to be determined and taken into account when controlling vehicles that travel the route in the near future, for example by controlling brake and steering actuators appropriately to keep the vehicle on the determined path or by increasing the speed in the knowledge that the friction is higher than previously estimated. This is particularly useful for autonomous vehicles, vehicles that travel the same route repeatedly, or vehicles that travel in convoys.

According to a first aspect of the disclosure, there is provided a computer system determining a difference in surface friction between a first set of surface conditions and a second set of surface conditions, the computer system comprising processing circuitry configured to receive first data corresponding to a first set of surface conditions, the first data comprising a first slip angle for at least one wheel of a vehicle, receive second data corresponding to a second set of surface conditions, the second data comprising a second slip angle for at least one wheel of a vehicle, compare the first slip angle and the second slip angle, and upon there being a difference between the first slip angle and the second slip angle, determine that a surface friction associated with the first set of surface conditions is different from a surface friction associated with the second set of surface conditions, wherein a lateral acceleration of the vehicle associated with the first data is substantially the same as a lateral acceleration of the vehicle associated with the second data.

The first aspect of the disclosure may seek to provide a solution for determining a difference in surface friction between different surface conditions. A technical benefit may include the indication of a change in surface friction from past or expected values, which can enable improved control of vehicles that travel the route in the near future.

Optionally in some examples, including in at least one preferred example, the processing circuitry is configured to determine the first slip angle and/or the second slip angle based on one or more of a longitudinal velocity vₓ, a lateral velocity v_{y}, a longitudinal acceleration aₓ, a lateral acceleration a_{y}, a steering angle δ, and/or a yaw rate ω of the respective vehicle. A technical benefit may include accurate determination of slip angles, leading to improved determination of any difference in surface friction.

Optionally in some examples, including in at least one preferred example, the processing circuitry is further configured to determine that the surface friction associated with the second set of surface conditions is lower than the surface friction value associated with the first set of surface conditions if the first slip angle is larger than the second slip angle. A technical benefit may include the determination of how the surface friction is changing, thus enabling control of vehicles that travel the route in the near future to be adapted accordingly.

Optionally in some examples, including in at least one preferred example, at least one of a vehicle load, vehicle speed, tyre type, tyre pressure, and tyre wear is substantially constant between the vehicle associated with the first data and the vehicle associated with the second data. A technical benefit may include ensuring a robust comparison between the different surface conditions, meaning that the likelihood of erroneous determinations is reduced.

Optionally in some examples, including in at least one preferred example, the lateral acceleration of the vehicle associated with the first data is within a threshold of the lateral acceleration of the vehicle associated with the second data. A technical benefit may include providing a simple and reliable way of ensuring a robust comparison between the different surface conditions.

Optionally in some examples, including in at least one preferred example, the processing circuitry is further configured to process the first data such that the lateral acceleration of the vehicle associated with the first data is substantially the same as the lateral acceleration of the vehicle associated with the second data. A technical benefit may include enabling the use of data that would otherwise not be useful for comparison between different surface conditions.

Optionally in some examples, including in at least one preferred example, the first data and the second data are associated with the same section of a route. A technical benefit may include the determination of a change of conditions of a section of a route over time, enabling vehicles that travel the same route in the near future to be controlled accordingly.

Optionally in some examples, including in at least one preferred example, the first data is received from a first real vehicle and the second data is received from a second real vehicle. A technical benefit may include the determination of a change of conditions by a first vehicle, enabling a second vehicle that travels the route in the near future, for example following in a convoy, to be controlled accordingly.

Optionally in some examples, including in at least one preferred example, one of the first or second data is received from a real vehicle, and the other of the first and second data is received from a vehicle model. A technical benefit may include the determination of a difference between real and modelled conditions, enabling control schemes for real vehicles, for example autonomous vehicles, to be adapted accordingly.

Optionally in some examples, including in at least one preferred example, the processing circuitry is further configured to determine a surface friction value associated with the second set of surface conditions. A technical benefit may include the determination of an accurate and up to date surface friction value that can be used in vehicle motion management to give reliable control.

According to a second aspect of the disclosure, there is provided a vehicle comprising the system.

According to a third aspect of the disclosure, there is provided a computer-implemented method for determining a difference in surface friction between a first set of surface conditions and a second set of surface conditions, the method comprising receiving, by processing circuitry of a computer system, first data corresponding to a first set of surface conditions, the first data comprising a first slip angle for at least one wheel of a vehicle, receiving, by the processing circuitry, second data corresponding to a second set of surface conditions, the second data comprising a second slip angle for at least one wheel of a vehicle, comparing, by the processing circuitry, the first slip angle and the second slip angle, and upon there being a difference between the first slip angle and the second slip angle, determining, by the processing circuitry, that a surface friction associated with the first set of surface conditions is different from a surface friction associated with the second set of surface conditions, wherein a lateral acceleration of the vehicle associated with the first data is substantially the same as a lateral acceleration of the vehicle associated with the second data.

The third aspect of the disclosure may seek to provide a solution for determining a difference in surface friction between different surface conditions. A technical benefit may include the indication of a change in surface friction from past or expected values, which can enable improved control of vehicles that travel the route in the near future.

Optionally in some examples, including in at least one preferred example, receiving the first and/or second data comprises determining, by the processing circuitry, the first slip angle and/or the second slip angle based on one or more of a longitudinal velocity vₓ, a lateral velocity v_{y}, a longitudinal acceleration aₓ, a lateral acceleration a_{y}, a steering angle δ, and/or a yaw rate ω of the respective vehicle. A technical benefit may include accurate determination of slip angles, leading to improved determination of any difference in surface friction.

Optionally in some examples, including in at least one preferred example, the computer-implemented method further comprises determining, by the processing circuitry, that the surface friction associated with the second set of surface conditions is lower than the surface friction value associated with the first set of surface conditions if the first slip angle is larger than the second slip angle. A technical benefit may include the determination of how the surface friction is changing, thus enabling control of vehicles that travel the route in the near future to be adapted accordingly.

Optionally in some examples, including in at least one preferred example, at least one of a vehicle load, vehicle speed, tyre type, tyre pressure, and tyre wear are substantially constant between the vehicle associated with the first data and the vehicle associated with the second data. A technical benefit may include ensuring a robust comparison between the different surface conditions, meaning that the likelihood of erroneous determinations is reduced.

Optionally in some examples, including in at least one preferred example, the lateral acceleration of the vehicle associated with the first data is within a threshold of the lateral acceleration of the vehicle associated with the second data. A technical benefit may include providing a simple and reliable way of ensuring a robust comparison between the different surface conditions.

Optionally in some examples, including in at least one preferred example, the computer-implemented method further comprises processing, by the processing circuitry, the first data such that the lateral acceleration of the vehicle associated with the first data is substantially the same as the lateral acceleration of the vehicle associated with the second data. A technical benefit may include enabling the use of data that would otherwise not be useful for comparison between different surface conditions.

Optionally in some examples, including in at least one preferred example, the first data and the second data are associated with the same section of a route. A technical benefit may include the determination of a change of conditions of a section of a route over time, enabling vehicles that travel the same route in the near future to be controlled accordingly.

Optionally in some examples, including in at least one preferred example, the first data is received from a first real vehicle and the second data is received from a second real vehicle. A technical benefit may include the determination of a change of conditions by a first vehicle, enabling a second vehicle that travels the route in the near future, for example following in a convoy, to be controlled accordingly.

Optionally in some examples, including in at least one preferred example, the first data is received from a real vehicle, and the second data is received from a vehicle model. A technical benefit may include the determination of a difference between real and modelled conditions, enabling control schemes for real vehicles, for example autonomous vehicles, to be adapted accordingly.

Optionally in some examples, including in at least one preferred example the computer-implemented method further comprises determining, by the processing circuitry, a surface friction value associated with the second set of surface conditions. A technical benefit may include the determination of an accurate and up to date surface friction value that can be used in vehicle motion management to give reliable control.

According to a fourth aspect of the disclosure, there is provided a computer program product comprising program code for performing, when executed by processing circuitry, the computer-implemented method.

According to a fifth aspect of the disclosure, there is provided a non-transitory computer-readable storage medium comprising instructions, which when executed by processing circuitry, cause the processing circuitry to perform the computer-implemented method.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a top-view of a vehicle, according to an example.

FIG. 2 is a plot of lateral tyre force against slip angle for different values of a surface friction coefficient, according to an example.

FIG. 3 is a flow chart of an example computer-implemented method according to an example.

FIG. 4 is a plot of lateral tyre force against slip angle for different operating points, according to an example.

FIG. 5 is a schematic diagram of an exemplary computer system for implementing examples disclosed herein, according to an example.

Like reference numerals refer to like elements throughout the description.

### DETAILED DESCRIPTION

The detailed description set forth below provides information and examples of the disclosed technology with sufficient detail to enable those skilled in the art to practice the disclosure.

In many vehicle operations, vehicles travel pre-defined routes repeatedly, for example delivery routes for heavy-duty vehicles, such as trucks. Increasingly, this is being performed by autonomous vehicles. Surface conditions may change between journeys, for example due to weather and other factors, which can result in a change in surface friction even when the same route is travelled by the same vehicle. Accurate and up to date knowledge of surface conditions, including surface friction, is crucial to safe transport.

To remedy this, systems, methods and other approaches are provided for determining a difference in surface friction between a first set of surface conditions and a second set of surface conditions. This is achieved by determining slip angles associated with the different sets of surface conditions, and comparing these slip angles. Upon there being a difference in the slip angle it can be determined that there is a difference in surface friction between the two sets of surface conditions. This can be taken into account when controlling vehicles that travel the route in the near future. For example, an updated surface friction value can be determined and used in control of brake and steering actuators to keep the vehicle on the determined path, or to allow an increase in vehicle speed where friction is sufficiently high. This is particularly useful for autonomous vehicles, vehicles that travel the same route repeatedly, or vehicles that travel in convoys. The approaches disclosed herein can be used in tandem with existing friction estimation models as a complement or a redundancy.

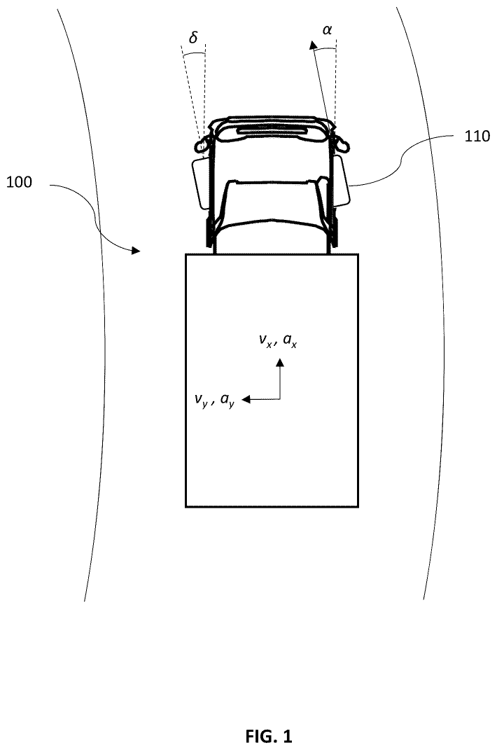

FIG. 1 schematically shows a top-view of an example vehicle 100 of the type considered in this disclosure. The vehicle 100 shown in FIG. 1 is an example of a truck, however the systems and methods disclosed herein can be used with any suitable form of vehicle 100. For example, the disclosure can be applied in heavy-duty vehicles, such as trucks, buses, and construction equipment, in personal vehicles such as cars, vans, or motorbikes, or in any other suitable form of vehicle. In some examples, the vehicle 100 may be a vehicle combination comprising a number of units, including a tractor unit and at least one trailing unit.

In the example of FIG. 1, the vehicle 100 is shown travelling on a curved path. FIG. 1 shows the relevant motion parameters of the vehicle 100. Examples of motion parameters of the vehicle 100 may include, for example, a longitudinal/axial velocity vₓ, a lateral/radial velocity v_{y}, a longitudinal/axial acceleration aₓ, a lateral/radial acceleration a_{y}, and/or a steering angle δ. Another relevant motion parameter is the yaw rate ω of the vehicle 100, which is the angular velocity of the rotation of the heading angle of the vehicle 100.

When the vehicle 100 is in motion, the wheels (or indeed tyres) 110 of the vehicle 100 experience slip. Slip can be expressed as the slip on the vehicle 100 as a whole, or the slip on a given wheel 110, and can be divided into longitudinal and lateral slip. These parameters are known in the art, and not discussed in detail here. However, it is noted that the slip angle α for a given wheel 110, i.e. the angle between the longitudinal dimension of the wheel 110 (the direction in which the wheel 110 is pointing) and the traveling direction of the wheel 110, can be defined as:

$$α = arctan ( \frac{{v}_{yw}}{{v}_{xw}} )$$

where v_{xw} is the longitudinal velocity of the wheel 110, and v_{yw} is the lateral velocity of the wheel 110.

In general, slip increases as surface friction decreases (e.g. there is more slip on ice than on asphalt). If slip is not controlled appropriately, it can lead to instability of the vehicle, for example off-tracking or, in the case of a vehicle combination comprising a number of units, jack-knifing or trailer swing. Whilst a curved path is shown in FIG. 1, it will be appreciated that the approaches disclosed herein are applicable to any situation where some lateral slip is present, including straight-line driving.

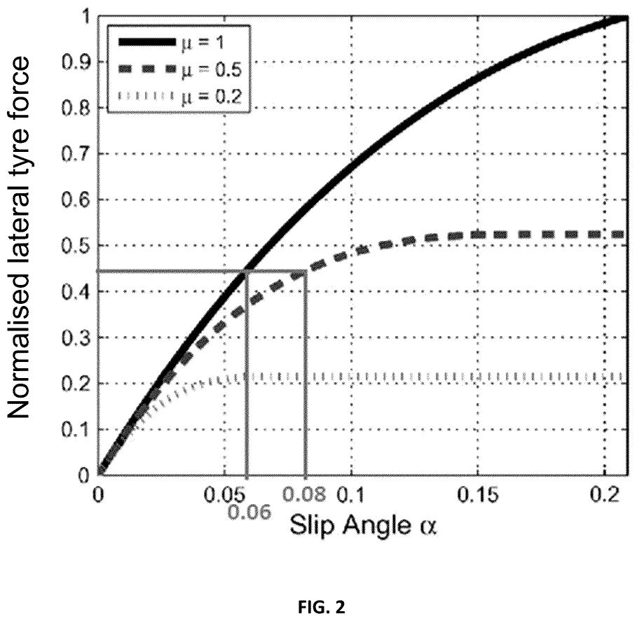

FIG. 2 is an example plot of the normalised lateral tyre force against slip angle for different values of a surface friction coefficient μ. The plot is taken from “Estimation of Tire Slip Angle and Friction Limits Using Steering Torque.” By Hsu, Yung-Hsiang Judy et al. IEEE Transactions on Control Systems Technology 18 (2010): 896-907. The lateral tyre force may be determined in any suitable manner known in the art. The normalised lateral tyre force is determined by dividing the lateral tyre force by the normal load on the wheel. Lateral force can be converted to lateral acceleration, and vice versa, using Newton's second law of motion.

As can be seen in FIG. 2, for small slip angles (for example less than around 0.2 radians), the lateral tyre force is relatively independent of the friction coefficient. Beyond this, the surface friction has a significant influence. As the slip angle increases, the lateral tyre force saturates and the vehicle understeers. The saturation point occurs at larger slip angles for higher surface friction. This means that a vehicle travelling on a relatively high friction surface can generate larger lateral tyre forces and therefore negotiate curves in a safer manner.

The concepts illustrated by the plot shown in FIG. 2 allow a difference in surface friction to be determined when the lateral tyre force, or a lateral acceleration of the vehicle 100, is the same. For example, for a given lateral tyre force, an increase in slip angle is indicative of a decrease in friction. Taking the example of FIG. 2, for a normalised lateral tyre force of 0.45, a slip angle of 0.6 radians indicates that the surface friction coefficient is 1, whereas a slip angle of 0.8 radians indicates that the surface friction coefficient is 0.5. It will be appreciated that different values will be relevant for different plots of normalised lateral tyre force against slip angle, which are dependent on tyre parameters.

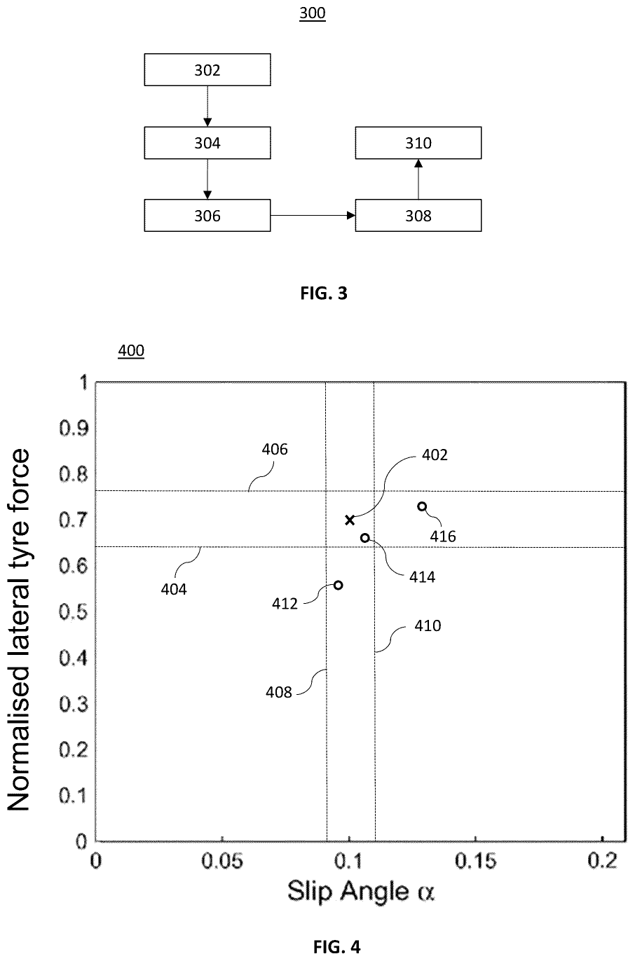

FIG. 3 is a flow chart of an example computer-implemented method 300 for determining a difference in surface friction between a first set of surface conditions and a second set of surface conditions according to an example. The method 300 may be performed by a control system of a vehicle, for example the vehicle 100 shown in the example of FIG. 1. The control system may be implemented on-board the vehicle, remotely from the vehicle, or a combination of the two.

At 302, first data corresponding to a first set of surface conditions is received. In particular, the data may be data pertinent to a vehicle 100 that is subject to the first set of surface conditions. Surface conditions may include a surface friction value, for example a surface friction coefficient pa. The surface conditions may also include a type of surface, a weather situation (e.g. dry, wet or icy conditions), a degree of curvature of a route, a slope of the route, a grade or camber of the route, and other conditions that may affect the motion of a vehicle. The data may be data from a vehicle 100 travelling a particular section of a route that has the first set of surface conditions. Alternatively, the data may be data from a computational model of a vehicle, where the model is used to determine how a vehicle would travel under the first set of surface conditions.

In particular, the data may include motion parameters of a vehicle 100 that is subject to the first set of surface conditions. The motion parameters may include, for example, a longitudinal velocity vₓ of the vehicle 100, a lateral velocity v_{y} of the vehicle 100, a longitudinal acceleration ax of the vehicle 100, a lateral acceleration a_{y} of the vehicle 100, a steering angle δ of the vehicle 100, a yaw rate ω of the vehicle 100, and/or a vehicle load. The motion parameters may also include wheel-related parameters such as the longitudinal velocity v_{xw} of the wheel 110, the lateral velocity v_{yw} of the wheel 110, a tyre type, a tyre pressure, and/or a tyre wear measurement.

In some examples, the data may include a slip angle α of at least one wheel 110 of a vehicle 100 that is subject to the first set of surface conditions. For example, the slip angle may be reported directly from a vehicle 100 or a computer model. In some examples, the slip angle is determined based on the longitudinal velocity v_{xw} and the lateral velocity v_{yw} of the wheel 110, as discussed above. In some examples, the lateral velocity v_{yw} of the wheel 110 is determined based on one or more of the lateral acceleration a_{y}, steering angle δ, and/or yaw rate ω of the vehicle 100, and/or a corner radius travelled by the vehicle 100. For example, as a larger slip angle α may be generated by further turning the steering wheel, the slip angle α may be determined directly from the steering angle δ. This ensures accurate determination of slip angles, leading to improved determination of any difference in surface friction.

At 304, second data corresponding to a second set of surface conditions is received. The second data may be data pertinent to a vehicle 100 that is subject to the second set of surface conditions. The second data may be substantially similar to the first data received at 302, in that the second set of surface conditions may comprise one or more of the same conditions as the first set of surface conditions, albeit those conditions may themselves be different (for example, the first set of surface conditions may be for a dry surface, while the second set of surface conditions may be for a wet surface). Similarly, the second data may include one or more of the same motion parameters as the first data, albeit those parameters may themselves be different (for example, a vehicle that is subject to the first set of surface conditions may be travelling at a higher speed than a vehicle that is subject to the second set of surface conditions). In the case that the first data comprises a slip angle for a specific wheel 110 (e.g. the front right wheel of a vehicle 100), the second data may also comprise a slip angle for that wheel 110.

In some examples, the first and second data are associated with the same section of a route. For example, the first and second data may be associated with the same road section, e.g. a particular curve on a particular road. The first data may be received from a vehicle 100 travelling along the road section at a first time, and the second data received from the same vehicle 100 travelling along the road section at a second time. The second time may be earlier or later than the first time. Alternatively, the first data may be received from a first vehicle 100, while the second data is received from a different vehicle 100 travelling along the same road section at a different time.

In some examples, the first and second data are associated with different sections of a route. For example, the first and second data may be associated with the different road sections, e.g. curves on different roads or different curves on the same road. The first data may be received from a vehicle 100 travelling along one road section, and the second data received from the same vehicle 100 travelling along a different road section. Alternatively, the first data may be received from a first vehicle 100 travelling along one road section, while the second data is received from a different vehicle 100 travelling along a different road section.

In some examples, one of the first or second data may be received from a real vehicle 100 and the other from a vehicle model. For example, a computational model of a vehicle 100 may be used to determine how a vehicle 100 would travel along a particular route. The modelled route may be geometrically similar to that travelled by the real vehicle 100, for example having curves with similar radius, length, and the like.

Whilst these different scenarios are possible for the first and second data, in order to make a robust and reliable comparison between them, it is important that a lateral acceleration a_{y} of the vehicle 100 associated with the first data is substantially the same as a lateral acceleration a_{y} of the vehicle 100 associated with the second data. This will ensure that the forces acting on the vehicle are sufficiently similar to make a relevant comparison.

To ensure this, it may be desirable that the lateral acceleration of the vehicle 100 associated with the first data is within a threshold of the lateral acceleration of the vehicle 100 associated with the second data, or vice versa. This provides a simple way to ensure the lateral accelerations are sufficiently similar. For example, it may be desirable that the lateral acceleration of the vehicle 100 associated with the first data is within a certain percentage of the lateral acceleration of the vehicle 100 associated with the second data, for example up to ±10%. This enables larger thresholds to be used for larger lateral accelerations, where larger lateral forces are at play. In some examples, it may be desirable that the lateral accelerations are within a certain percentage of each other. In other examples, the threshold can be an absolute threshold, for example up to ±0.3 m/s².

In some examples, when the lateral accelerations are not within a threshold of each other, one set of data may be processed at 306 in order to bring the lateral accelerations in line. For example, one set of data may be extrapolated such that the lateral accelerations are substantially the same. For example, a look up table approach can be used to extrapolate the slip angle when the loading of the vehicle, vehicle type and/or other parameters are considerably different between the first a second sets of data. The resulting slip angles can then be used in the next step.

In some examples, in order to provide the most reliable comparison between slip angles, further parameters of the first and second data that may affect the slip angle of a vehicle 100 may also need to be similar or the same. For example, loading of the vehicle 100 or tyre wear may affect how the slip angle develops under certain lateral accelerations. Therefore, it may be desirable that at least one of a vehicle load, vehicle speed, tyre type, tyre pressure, and tyre wear is substantially constant between the vehicle 100 associated with the first data and the vehicle 100 associated with the second data. For example, it may be desirable that at least one of the parameters for the first data is within a threshold of the corresponding parameter for the second data, or vice versa. The threshold may be a percentage or an absolute value.

At 308, the slip angle associated with the first data and the slip angle associated with the second data are compared. For example, it may be determined if the slip angle associated with the first data is within a threshold of the slip angle associated with the second data, or vice versa. The threshold may be a percentage or an absolute value. In the case that a threshold was used to compare the lateral accelerations of the first and second data, corresponding thresholds may be used for the corresponding slip angles. In the case that the first and second data comprise slip angles for a plurality of wheels 110 of a vehicle 100, the comparison should be made for a specific one of the wheels (e.g. the front right wheel).

At 310, upon there being a difference between the slip angle associated with the first data and the slip angle associated with the second data, it is determined that a surface friction associated with the first set of surface conditions is different from a surface friction associated with the second set of surface conditions. This is because it can be concluded that, for cases with similar lateral accelerations, any difference in slip angle will be due to a difference in surface friction.

If the first slip angle is larger than the second slip angle, it can be determined that the surface friction associated with the second set of surface conditions is lower than the surface friction value associated with the first set of surface conditions. This is because more slip will occur in conditions with lower friction. Conversely, if the first slip angle is smaller than the second slip angle, it can be determined that the surface friction associated with the second set of surface conditions is higher than the surface friction value associated with the first set of surface conditions.

An example is shown in FIG. 4, which is a plot 400 of normalised lateral tyre force against slip angle. The plot 400 shows a first example operating point 402, which corresponds to a first set of data and a first set of surface conditions. The first operating point 402 has a normalised lateral tyre force of 0.7. In this example, a threshold of ±10% is applied, meaning a lower threshold 404 is set at 0.63 and an upper threshold 406 is set at 0.77. Therefore, for a second operating point that corresponds to a second set of data and a second set of surface conditions to be considered for a comparison of slip angles, it would need to have a normalised lateral tyre force between 0.63 and 0.77. The slip angles can then be compared to determine if there is a difference. In some examples, similar thresholds can be used to determine if the slip angles are sufficiently similar or different for a conclusion to be made. For example, as the first operating point 402 has a slip angle of 0.1 radians, a threshold of ±10% results in a lower threshold 408 set at 0.09 radians and an upper threshold 412 set at 0.11 radians. Therefore, for the slip angle of a second operating point to be considered sufficiently different from the first operating point 402, it would need to be outside the range of 0.09 radians to 0.11 radians.

Three further example operating points 412, 414, 416 are shown in FIG. 4, each corresponding to a particular set of surface conditions. The operating point 412 has a normalised lateral tyre force of 0.57, meaning it is outside the threshold for lateral tyre force, and therefore not considered useful for comparison to the first operating point 402. The operating point 414 has a normalised lateral tyre force of 0.67, meaning it is inside the threshold for lateral force and can be used for comparison (it should be noted that, applying a threshold of ±10% to the operating point 414 gives values of 0.603 and 0.737, meaning that the first operating point 402 is also inside the threshold for lateral force the operating point 414). The operating point 414 has a slip angle of 0.105 radians, meaning it can be concluded that the associated surface friction is similar to that of the first operating point 402, and therefore that there is no significant difference in surface conditions from the first operating point 402. The operating point 416 has a normalised lateral tyre force of 0.74, meaning it is inside the threshold for lateral force and can be used for comparison (it should be noted that, applying a threshold of ±10% to the operating point 416 gives values of 0.666 and 0.814, meaning that the first operating point 402 is also inside the threshold for lateral force the operating point 416). The operating point 416 has a slip angle of 0.13 radians, meaning it is concluded that the associated surface friction is different to that of the first operating point 402. Therefore, it can be concluded that there a difference in surface conditions from the first operating point 402.

Returning to FIG. 3, at 312, an action can be taken based on the determination at step 310. For example, a vehicle might be travelling at pre-defined speeds along a GPS tracked route. Data corresponding to a dry surface can be used as reference, and any differences can be determined and suitable preventive action can be applied. The reference data can be determined using a real vehicle or a computer model. In some examples, a surface friction value, such a surface friction coefficient, can be determined for the second set of surface conditions. This could be achieved, for example, using a specifically trained machine learning algorithm. This can be taken into account when controlling vehicles that travel the route in the near future, for example by controlling brake and steering actuators to keep the vehicle on the determined path, or by increasing the speed knowing that the friction is higher than previously estimated.

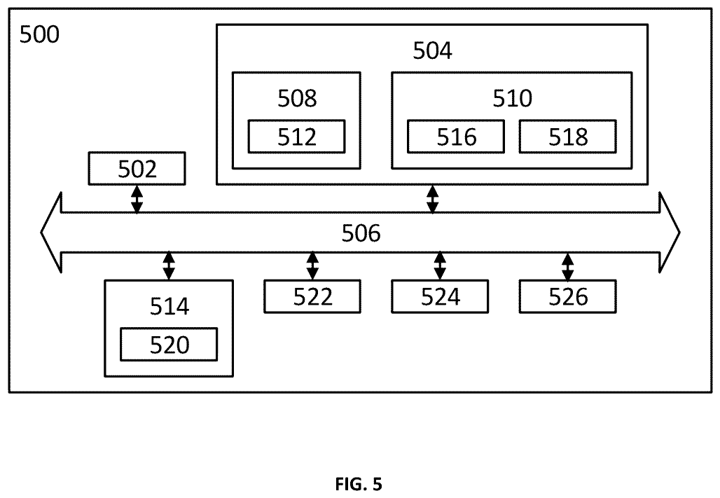

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN, an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:
Example 1. A computer system for determining a difference in surface friction between a first set of surface conditions and a second set of surface conditions, the computer system comprising processing circuitry configured to:
   receive (302) first data corresponding to a first set of surface conditions, the first data comprising a first slip angle for at least one wheel of a vehicle (100);
   receive (304) second data corresponding to a second set of surface conditions, the second data comprising a second slip angle for at least one wheel of a vehicle (100);
   compare (308) the first slip angle and the second slip angle; and
   upon there being a difference between the first slip angle and the second slip angle, determine (310) that a surface friction associated with the first set of surface conditions is different from a surface friction associated with the second set of surface conditions;
   wherein a lateral acceleration of the vehicle associated with the first data is substantially the same as a lateral acceleration of the vehicle associated with the second data.
Example 2. The computer system of example 1, wherein the processing circuitry is configured to receive (302, 304) the first and/or second data by determining the first slip angle and/or the second slip angle based on one or more of a longitudinal velocity vₓ, a lateral velocity v_{y}, a longitudinal acceleration aₓ, a lateral acceleration a_{y}, a steering angle δ, and/or a yaw rate ω of the respective vehicle (100).
Example 3. The computer system of example 1 or 2, wherein the processing circuitry is further configured to determine that the surface friction associated with the second set of surface conditions is lower than the surface friction value associated with the first set of surface conditions if the first slip angle is larger than the second slip angle.
Example 4. The computer system of any preceding example, wherein at least one of a vehicle load, vehicle speed, tyre type, tyre pressure, and tyre wear is substantially constant between the vehicle (100) associated with the first data and the vehicle (100) associated with the second data.
Example 5. The computer system of any preceding example, wherein the lateral acceleration of the vehicle (100) associated with the first data is within a threshold of the lateral acceleration of the vehicle (100) associated with the second data.
Example 6. The computer system of any preceding example, wherein the processing circuitry is further configured to process (306) the first data such that the lateral acceleration of the vehicle (100) associated with the first data is substantially the same as the lateral acceleration of the vehicle (100) associated with the second data.
Example 7. The computer system of any preceding example, wherein the first data and the second data are associated with the same section of a route.
Example 8. The computer system of any preceding example, wherein the first data is received from a first real vehicle (100) and the second data is received from a second real vehicle (100).
Example 9. The computer system of any of examples 1 to 6, wherein one of the first or second data is received from a real vehicle (100), and the other of the first and second data is received from a vehicle model.
Example 10. The computer system of any preceding example, wherein the processing circuitry is further configured to determine (312) a surface friction value associated with the second set of surface conditions.
Example 11. A vehicle (100) comprising the computer system of any preceding example.
Example 12. A computer-implemented method (300) for determining a difference in surface friction between a first set of surface conditions and a second set of surface conditions, the method comprising:
   receiving (302), by processing circuitry of a computer system, first data corresponding to a first set of surface conditions, the first data comprising a first slip angle for at least one wheel of a vehicle (100);
   receiving (304), by the processing circuitry, second data corresponding to a second set of surface conditions, the second data comprising a second slip angle for at least one wheel of a vehicle (100);
   comparing (308), by the processing circuitry, the first slip angle and the second slip angle; and
   upon there being a difference between the first slip angle and the second slip angle, determining (310), by the processing circuitry, that a surface friction associated with the first set of surface conditions is different from a surface friction associated with the second set of surface conditions;
   wherein a lateral acceleration of the vehicle associated with the first data is substantially the same as a lateral acceleration of the vehicle associated with the second data.
Example 13. The computer-implemented method of example 12, wherein receiving (302, 304) the first and/or second data comprises determining, by the processing circuitry, the first slip angle and/or the second slip angle based on one or more of a longitudinal velocity vₓ, a lateral velocity v_{y}, a longitudinal acceleration aₓ, a lateral acceleration a_{y}, a steering angle δ, and/or a yaw rate ω of the respective vehicle (100).
Example 14. The computer-implemented method of example 12 or 13, further comprising determining, by the processing circuitry, that the surface friction associated with the second set of surface conditions is lower than the surface friction value associated with the first set of surface conditions if the first slip angle is larger than the second slip angle.
Example 15. The computer-implemented method of any of examples 12 to 14, wherein at least one of a vehicle load, vehicle speed, tyre type, tyre pressure, and tyre wear is substantially constant between the vehicle (100) associated with the first data and the vehicle (100) associated with the second data.
Example 16. The computer-implemented method of any of examples 12 to 15, wherein the lateral acceleration of the vehicle (100) associated with the first data is within a threshold of the lateral acceleration of the vehicle (100) associated with the second data.
Example 17. The computer-implemented method of any of examples 12 to 16, further comprising processing (306) the first data such that the lateral acceleration of the vehicle (100) associated with the first data is substantially the same as the lateral acceleration of the vehicle (100) associated with the second data.
Example 18. The computer-implemented method of any of examples 12 to 17, wherein the first data and the second data are associated with the same section of a route.
Example 19. The computer-implemented method of any of examples 12 to 18, wherein the first data is received from a first real vehicle (100) and the second data is received from a second real vehicle (100).
Example 20. The computer-implemented method of any of examples 12 to 17, wherein the first data is received from a real vehicle (100), and the second data is received from a vehicle model.
Example 21. The computer-implemented method of any of examples 12 to 20, further comprising determining (312), by the processing circuitry, a surface friction value associated with the second set of surface conditions.
Example 22. A computer program product comprising program code for performing, when executed by processing circuitry, the computer-implemented method of any of examples 12 to 21.
Example 23. A non-transitory computer-readable storage medium comprising instructions, which when executed by processing circuitry, cause the processing circuitry to perform the computer-implemented method of any of examples 12 to 21.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for determining a difference in surface friction between a first set of surface conditions and a second set of surface conditions, the computer system comprising processing circuitry configured to:
receive first data corresponding to a first set of surface conditions, the first data comprising a first slip angle for at least one wheel of a vehicle;
receive second data corresponding to a second set of surface conditions, the second data comprising a second slip angle for at least one wheel of a vehicle;
compare the first slip angle and the second slip angle; and
upon there being a difference between the first slip angle and the second slip angle, determine that a surface friction associated with the first set of surface conditions is different from a surface friction associated with the second set of surface conditions;
wherein a lateral acceleration of the vehicle associated with the first data is substantially the same as a lateral acceleration of the vehicle associated with the second data.

2. The computer system of claim 1, wherein the processing circuitry is configured to receive the first and/or second data by determining the first slip angle and/or the second slip angle based on one or more of a longitudinal velocity vₓ, a lateral velocity v_{y}, a longitudinal acceleration aₓ, a lateral acceleration a_{y}, a steering angle δ, and/or a yaw rate ω of the respective vehicle.

3. The computer system of claim 1, wherein the processing circuitry is further configured to determine that the surface friction associated with the second set of surface conditions is lower than the surface friction value associated with the first set of surface conditions if the first slip angle is larger than the second slip angle.

4. The computer system of claim 1, wherein at least one of a vehicle load, vehicle speed, tyre type, tyre pressure, and tyre wear is substantially constant between the vehicle associated with the first data and the vehicle associated with the second data.

5. The computer system of claim 1, wherein the lateral acceleration of the vehicle associated with the first data is within a threshold of the lateral acceleration of the vehicle associated with the second data.

6. The computer system of claim 1, wherein the processing circuitry is further configured to process the first data such that the lateral acceleration of the vehicle associated with the first data is substantially the same as the lateral acceleration of the vehicle associated with the second data.

7. The computer system of claim 1, wherein the first data and the second data are associated with the same section of a route.

8. The computer system of claim 1, wherein the first data is received from a first real vehicle and the second data is received from a second real vehicle.

9. The computer system of claim 1, wherein one of the first or second data is received from a real vehicle, and the other of the first and second data is received from a vehicle model.

10. The computer system of claim 1, wherein the processing circuitry is further configured to determine a surface friction value associated with the second set of surface conditions.

11. A vehicle comprising the computer system of claim 1.

12. A computer-implemented method for determining a difference in surface friction between a first set of surface conditions and a second set of surface conditions, the method comprising:
receiving, by processing circuitry of a computer system, first data corresponding to a first set of surface conditions, the first data comprising a first slip angle for at least one wheel of a vehicle;
receiving, by the processing circuitry, second data corresponding to a second set of surface conditions, the second data comprising a second slip angle for at least one wheel of a vehicle;
comparing, by the processing circuitry, the first slip angle and the second slip angle; and
upon there being a difference between the first slip angle and the second slip angle, determining, by the processing circuitry, that a surface friction associated with the first set of surface conditions is different from a surface friction associated with the second set of surface conditions;
wherein a lateral acceleration of the vehicle associated with the first data is substantially the same as a lateral acceleration of the vehicle associated with the second data.

13. The computer-implemented method of claim 12, wherein receiving the first and/or second data comprises determining, by the processing circuitry, the first slip angle and/or the second slip angle based on one or more of a longitudinal velocity vₓ, a lateral velocity v_{y}, a longitudinal acceleration aₓ, a lateral acceleration a_{y}, a steering angle δ, and/or a yaw rate ω of the respective vehicle.

14. The computer-implemented method of claim 12, wherein at least one of a vehicle load, vehicle speed, tyre type, tyre pressure, and tyre wear is substantially constant between the vehicle associated with the first data and the vehicle associated with the second data.

15. The computer-implemented method of claim 12, wherein the lateral acceleration of the vehicle associated with the first data is within a threshold of the lateral acceleration of the vehicle associated with the second data.

16. The computer-implemented method of claim 12, wherein the first data and the second data are associated with the same section of a route.

17. The computer-implemented method of claim 12, wherein the first data is received from a first real vehicle and the second data is received from a second real vehicle.

18. The computer-implemented method of claim 12, wherein the first data is received from a real vehicle, and the second data is received from a vehicle model.

19. A computer program product comprising program code for performing, when executed by processing circuitry, the computer-implemented method of claim 12.

20. A non-transitory computer-readable storage medium comprising instructions, which when executed by processing circuitry, cause the processing circuitry to perform the computer-implemented method of claim 12.
